(19) United States
(12) Patent Application Publication
(10) Pub. No.: US 2021/0125200 A1
(43) Pub. Date: Apr. 29, 2021

(54) METHOD AND SYSTEM FOR PREDICTING MEDIUM-LONG TERM WATER DEMAND OF WATER SUPPLY NETWORK

(71) Applicant: JILIN JIANZHU UNIVERSITY, Changchun (CN)

(72) Inventors: Yingzi Lin, Changchun (CN); Gen Liu, Changchun (CN); Lan Liu, Changchun (CN); Zeming Zhao, Changchun (CN); Ang Li, Changchun (CN); Huan Lin, Changchun (CN); Ruijun Ren, Changchun (CN); Yang Zhu, Changchun (CN)

(73) Assignee: JILIN JIANZHU UNIVERSITY, Changchun (CN)

(21) Appl. No.: 16/706,987

(22) Filed: Dec. 9, 2019

(30) Foreign Application Priority Data
Oct. 28, 2019 (CN) 201911028929.4

(51) Int. Cl. G06Q 30/02; G06N 3/08

(52) U.S. Cl. CPC G06Q 30/0202; G06N 3/08

(57) ABSTRACT

A method and a system for predicting a medium-long term water demand of a water supply network including: building a gray model; acquiring an urban historical water demand data set; processing the historical water demand data set to obtain a processed water demand data set; inputting the processed water demand data set into the gray model to obtain a medium-long term water demand prediction value; acquiring a medium-long term water demand actual value; obtaining a first prediction error according to the medium-long term water demand prediction value and the medium-long term water demand actual value; inputting the first prediction error into an artificial neutral network model to repeatedly conduct a prediction so as to obtain a second prediction error; predicting a medium-long term water demand of the water supply network according to the medium-long term water demand prediction value and the second prediction error.

### TECHNICAL FIELD

The present invention relates to the field of water supply network water demand prediction, and in particular, to a method and a system for predicting a medium-long term water demand of a water supply network.

### BACKGROUND

Urban water demand prediction specifically is as follows: an urban water demand in a future time is predicted by utilizing a scientific system method or an empirical mathematical method and simultaneously considering subjective and objective factors such as economy and society, and influence of weather conditions and the like based on urban historical water consumption data when a certain accuracy constraints are met.

Urban medium-long term scientific and reasonable water demand prediction is a premise and a foundation of planning and extending in a water supply network system, so the urban water demand prediction is of important significance.

With the continuous development of a prediction model, domestic and international scholars conduct a large amount of researches on the urban water demand prediction by utilizing various prediction models and prediction methods such as time series, regression analysis, artificial neural networks and the like; and if a water consumption historical record of a certain city is less and is short in time, a gray model is suitable for being selected to conduct medium-long term water demand prediction. The gray model requires less information during modeling, and can ignore a change trend and a distribution rule and greatly reflect actual condition of the system so as to have advantages of operation convenience and the like. However, when data in the model shows a great discrete degree, the accuracy of the gray model is reduced; during long term water demand prediction, the accuracy can be improved by continuously extending new data, that is, if the water consumption historical record of a certain city is less, it is of a certain deficiency to select the gray model to conduct the medium-long term water demand prediction, so the gray model needs to be improved to accurately predict the water demand of the city.

### SUMMARY

An objective of the present invention is to provide a method and a system for predicting a medium-long term water demand of a water supply network, which can accurately predict an urban water demand.

To achieve the above purpose, the present invention provides the following technical solutions.

A method for predicting a medium-long term water demand of a water supply network includes:

building a predicting module

acquiring an urban historical water demand data set;

processing the historical water demand data set by utilizing a sliding average method to obtain a processed water demand data set;

inputting the processed water demand data set into the gray model to obtain a medium-long term water demand prediction value;

acquiring a medium-long term water demand actual value;

calculating a difference between the medium-long term water demand prediction value and the medium-long term water demand actual value to obtain a first prediction error;

inputting the first prediction error into an artificial neutral network model to repeatedly conduct a prediction so as to obtain a second prediction error,

predicting a medium-long term water demand of the water supply network according to the medium-long term water demand prediction value and the second prediction error.

Optionally, the processing the historical water demand data set to obtain a processed water demand data set specifically includes:

processing the historical water demand data set by utilizing a moving average method to obtain a processed water demand data set.

Optionally, the obtaining a first prediction error according to the medium-long term water demand prediction value and the medium-long term water demand actual value specifically includes:

calculating a difference between the medium-long term water demand prediction value and the medium-long term water demand actual value to obtain a first prediction error.

Optionally, between the calculating a difference between the medium-long term water demand prediction value and the medium-long term water demand actual value to obtain a first prediction error and the inputting the first prediction error into an artificial neutral network model to repeatedly conduct a prediction so as to obtain a second prediction error, the method further includes:

training the artificial neural network model according to the historical water demand data set.

A system for predicting a medium-long term water demand of a water supply network includes:

a gray model building module, used for building a gray model;

a data set acquiring module, used for acquiring an urban historical water demand data set;

a data set processing module, used for processing the historical water demand data set to obtain a processed water demand data set;

a medium-long term water demand prediction value determining module, used for inputting the processed water demand data set into the gray model to obtain a medium-long term water demand prediction value;

a water demand actual value acquiring module, used for acquiring a medium-long term water demand actual value;

a first prediction error determining module, used for obtaining a first prediction error according to the medium-long term water demand prediction value and the medium-long term water demand actual value;

a second prediction error determining module, used for inputting the first prediction error into an artificial neutral network model to repeatedly conduct a prediction so as to obtain a second prediction error; and

a water supply network medium-long term water demand predicting module, used for predicting a medium-long term water demand of the water supply network according to the medium-long term water demand prediction value and the second prediction error.

Optionally, the data set processing module specifically includes:

a data set processing unit used for processing the historical water demand data set by utilizing a moving average method to obtain a processed water demand data set.

Optionally, the first prediction error determining module specifically includes:

a first prediction error determining unit used for calculating a difference between the medium-long term water demand prediction value and the medium-long term water demand actual value to obtain a first prediction error.

Optionally, the system further includes:

a training module used for training the artificial neural network model according to the historical water demand data set.

According to specific embodiments provided in the present invention, the present invention discloses the following technical effects.

The present invention provides a method for predicting a medium-long term water demand of a water supply network, including: building a gray model; acquiring an urban historical water demand data set; processing the historical water demand data set to obtain a processed water demand data set; inputting the processed water demand data set into the gray model to obtain a medium-long term water demand prediction value; acquiring a medium-long term water demand actual value; obtaining a first prediction error according to the medium-long term water demand prediction value and the medium-long term water demand actual value; inputting the first prediction error into an artificial neutral network model to repeatedly conduct a prediction so as to obtain a second prediction error; and predicting a medium-long term water demand of the water supply network according to the medium-long term water demand prediction value and the second prediction error. By utilizing the method of the present invention, the urban water demand can be accurately predicted.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other accompanying drawings from these accompanying drawings without creative efforts.

FIG. 1 is a flow chart of a method for predicting a medium-long term water demand of a water supply network of the present invention.

FIG. 2 is a schematic structural diagram of a system for predicting a medium-long term water demand of a water supply network of the present invention.

### DETAILED DESCRIPTION

The following clearly and completely describes the technical solutions in the embodiments of the present invention with reference to accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a method and a system for predicting a medium-long term water demand of a water supply network, which can accurately predict an urban water demand.

In order to make the above objects, features, and advantages of the present invention more apparent, the present invention will be further described in detail in connection with the accompanying drawings and the detailed description.

A time series method is a method for analyzing various dependent and ordered discrete data sets. For example, data of every hour (every day, every week, every month and every year) in a water supply network system is monitored and recorded to obtain a discrete data set of a water demand, where t1<t2< . . . <tN, generally t2−t1=t3−t2= . . . =tN−tN−1. Its advantages are: the time series method thinks that each data in a time series reflects a result synthetically acted by current numerous influence factors, and the whole time series reflects a change procedure of a prediction object under synthetic action of the numerous influence factors. Assuming that the change of the prediction object is only associated with time, the prediction procedure only depends on the historical data and ignores other influence factors such that a prediction research is more direct and convenient. Its disadvantages are: in practice, the time series is hard to be described by using a completely specified function or function group, utilizes the system as a black box, and does not consider operating factors influencing the system.

A regression analysis method is also called as explanatory prediction, if assuming an input and an output of a system have a certain causal relationship, an input variable causes variation of an output variable of the system, and the variation is a constant. Its advantages are: a prediction model built by using the regression analysis can not only be used for predicting, but also explain a relationship of causes operating in the system and each factor. Its disadvantages are: multiple types and a large amount of historical data are required.

An artificial neural network (ANN) is also called as a neural network (NN), it is a mathematical algorithm model which simulates behavior characteristics of an animal neural network to conduct distributed parallel information processing, and a typical example is a back propagation (BP) neural network. Its advantages are: simplicity, feasibility, small amount of calculation, strong parallelism, and strong nonlinear mapping ability. Its disadvantages are: less rate of convergence, existence of local minimum, and uncertainty of numbers of hidden layers and hidden layer nodes of the BP neural network.

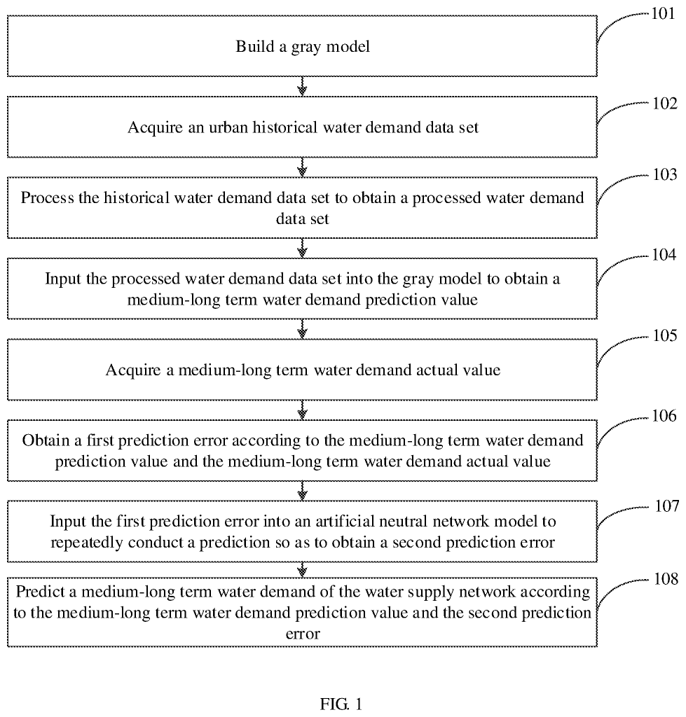

FIG. 1 is a flow chart of a method for predicting a medium-long term water demand of a water supply network of the present invention. As shown in FIG. 1, the method for predicting a medium-long term water demand of a water supply network includes:

step 101: build a gray model;

step 102: acquire an urban historical water demand data set;

where a gray model is built by running matlab software, a general expression is GM (n, x), its meaning is: model x variables by using an n-order differential equation to obtain GM (1, 1), and a prediction model equation is:

\hat{q}⁽⁰⁾(k+1)=\hat{q}⁽¹⁾(k+1)−\hat{q}⁽¹⁾(k)

where \hat{q}⁽⁰⁾ represents an array formed by the historical actual water demand data; and \hat{q}⁽¹⁾ represents a first-order gray equation formed by the historical actual water demand data \hat{q}⁽⁰⁾. q⁽⁰⁾={q₍₀₎(1),q₍₀₎(2), . . . ,q₍₀₎(n)} a historical actual water demand sequence.

step 103: process the historical water demand data set to obtain a processed water demand data set, which specifically includes:

process the historical water demand data set by utilizing a moving average method to obtain a processed water demand data set;

where an array formed by the historical water demand data set has two endpoints \hat{q}⁽¹⁾(1) and \hat{q}⁽¹⁾(n), the middle portion is represented as \hat{q}⁽¹⁾(k), transformation formulas of the two endpoints are:

$${\hat{q}}^{( 0 )} ( 1 ) = \frac{3 {q}^{( 0 )} ( 1 ) + {q}^{( 0 )} ( 2 )}{4}$$

$${\hat{q}}^{( 0 )} ( n ) = \frac{{q}^{( 0 )} ( n - 1 ) + 3 {q}^{( 0 )} ( n )}{4}$$

a transformation formula of a middle portion substitute is as:

$${\hat{q}}^{( 0 )} ( k ) = \frac{{q}^{( 0 )} ( k - 1 ) + 2 {q}^{( 0 )} ( k ) + {q}^{( 0 )} ( k + 1 )}{4}$$

and Q is used for representing a water demand data set Q=(q⁽⁰⁾(1), q⁽⁰⁾(n), q⁽⁰⁾(k)) after the moving average processing;

step 104: input the processed water demand data set into the gray model to obtain a medium-long term water demand prediction value;

where the water demand data set Q is inputted into the GM (1, 1) to obtain a medium-long term water demand prediction value; and the GM (1, 1) is a common gray model;

step 105: acquire a medium-long term water demand actual value;

step 106: obtain a first prediction error according to the medium-long term water demand prediction value and the medium-long term water demand actual value, which specifically includes:

calculate a difference between the medium-long term water demand prediction value and the medium-long term water demand actual value to obtain a first prediction error;

step 107: input the first prediction error into an artificial neutral network model to repeatedly conduct a prediction so as to obtain a second prediction error, which specifically includes:

repeatedly predict by utilizing the first prediction error as an input of the artificial neutral network model, and output a new prediction error;

where a training procedure is to build a 2*10 matrix formed by historical water demand data of 10 years by running a neural fitting module in matlab2018a (where error data is trained), the first column is actual water demand data of 10 years, the second column is prediction data of 10 years, and a matrix A set;

the GM (1, 1) is not a particular research content of the present invention, so it is not described herein and only an error is set to be a matrix B;

the error is used for repeatedly building a 1*10 error matrix, and the error matrix is obtained by reducing data predicted by the gray model from the actual data; the 2*10 matrix A is utilized as input, (input is a column needing to be inputted in the neural fitting in the main interface APP tool column in the matlab2018a; entering the neural fitting is displayed, and its essence is a training sample), the first column and the second column respectively are the actual historical data and historical data predicted by the gray model and processed by the moving average method, the 1*10 error matrix B is utilized as target, and parameter settings are as follows:

training: 70%;

validation: 15%;

testing: 15%;

a hidden layer neuron is defaulted to be 10;

the above parameters are default values of software built-in modules and can be adjusted by self without actual meanings;

click train till R² (a fitting coefficient) is greater than 99.999%;

step 108: predict a medium-long term water demand of the water supply network according to the medium-long term water demand prediction value and the second prediction error.

Between the step 105 and the step 106, the method further includes:

train the artificial neural network model according to the historical water demand data set.

Water demand historical records of some cities are less and are short in time, so the gray model is suitable for being selected to conduct the medium-long term water demand prediction. Furthermore, the gray model requires less information during modeling, and can ignore a change trend and a distribution rule and greatly reflect actual condition of the system so as to have advantages of operation convenience and the like. However, when data in the model shows a great discrete degree, the accuracy of the gray model is reduced; during long term water demand prediction, the accuracy can be improved by continuously extending new data.

The artificial neural network prediction model is a prediction model simulating a brain neuron network structure and working principle, and works based on forward propagation in an input mode and reverse propagation of the errors. The brain of a human body is a complex tissue structure, so the artificial neural network merely reflects some basic characteristics of the brain of the human body, but not completely and truly reproduce the brain of the human body. It is only partial simulation, abstraction and simplification of the brain of the human body.

The moving average method is as follows: calculate an average motion value by sequentially and gradually increasing or reducing new or old data based on a simple average method so as to eliminate accidental variable factors, find out development trends of things and predict based on this. Data is small equally weighted, recent data is greatly weighted, and forward data is small weighted, which aim to strengthen functions of the recent data and weaken influences of the forward data.

The method of the present invention improves the original data, and transform the original data by using the moving average method to achieve an objective of avoiding excessive volatility of values and increasing the current data weights, and utilizes the processed data to build the gray model to obtain the initial prediction value, utilizes an error between the initial prediction value and the actual value to build a BP neural network residual correction model to correct the initial prediction value, and finally outputs the prediction value.

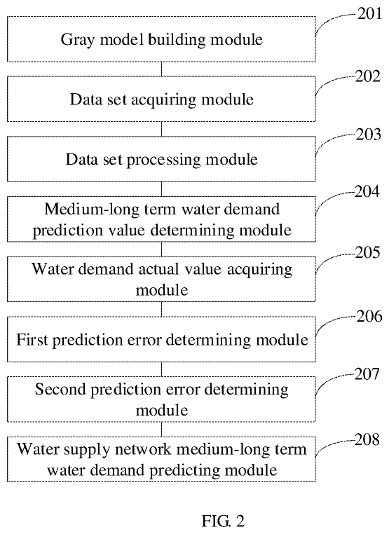

FIG. 2 is a schematic structural diagram of a system for predicting a medium-long term water demand of a water supply network of the present invention. As shown in FIG. 2, the system for predicting a medium-long term water demand of a water supply network includes:

a gray model building module 201, used for building a gray model;

a data set acquiring module 202, used for acquiring an urban historical water demand data set;

a data set processing module 203, used for processing the historical water demand data set to obtain a processed water demand data set;

a medium-long term water demand prediction value determining module 204, used for inputting the processed water demand data set into the gray model to obtain a medium-long term water demand prediction value;

a water demand actual value acquiring module 205, used for acquiring a medium-long term water demand actual value;

a first prediction error determining module 206, used for obtaining a first prediction error according to the medium-long term water demand prediction value and the medium-long term water demand actual value;

a second prediction error determining module 207, used for inputting the first prediction error into an artificial neutral network model to repeatedly conduct a prediction so as to obtain a second prediction error; and a water supply network medium-long term water demand predicting module 208, used for predicting a medium-long term water demand of the water supply network according to the medium-long term water demand prediction value and the second prediction error.

The data set processing module 203 specifically includes:

a data set processing unit used for processing the historical water demand data set by utilizing a moving average method to obtain a processed water demand data set.

The first prediction error determining module 206 specifically includes:

a first prediction error determining unit used for calculating a difference between the medium-long term water demand prediction value and the medium-long term water demand actual value to obtain a first prediction error.

The system for predicting a medium-long term water demand of a water supply network of the present invention further includes:

a training module used for training the artificial neural network model according to the historical water demand data set.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and its core principles of the present invention. In addition, a person of ordinary skill in the art can make various modifications in terms of specific embodiments and scope of application in accordance with the teachings of the present invention. In conclusion, the content of this specification shall not be construed as a limitation to the present invention.

What is claimed is:

1. A method for predicting a medium-long term water demand of a water supply network, comprising:
building a predicting module
acquiring an urban historical water demand data set;
processing the historical water demand data set by utilizing a sliding average method to obtain a processed water demand data set;
inputting the processed water demand data set into the gray model to obtain a medium-long term water demand prediction value;
acquiring a medium-long term water demand actual value;
calculating a difference between the medium-long term water demand prediction value and the medium-long term water demand actual value to obtain a first prediction error;
inputting the first prediction error into an artificial neutral network model to repeatedly conduct a prediction so as to obtain a second prediction error,
predicting a medium-long term water demand of the water supply network according to the medium-long term water demand prediction value and the second prediction error.

2. The method for predicting a medium-long term water demand of a water supply network according to claim 1, wherein the processing the historical water demand data set to obtain a processed water demand data set specifically comprises:
processing the historical water demand data set by utilizing a moving average method to obtain a processed water demand data set.

3. The method for predicting a medium-long term water demand of a water supply network according to claim 1, wherein the obtaining a first prediction error according to the medium-long term water demand prediction value and the medium-long term water demand actual value specifically comprises:
calculating a difference between the medium-long term water demand prediction value and the medium-long term water demand actual value to obtain a first prediction error.

4. The method for predicting a medium-long term water demand of a water supply network according to claim 1, between the calculating a difference between the medium-long term water demand prediction value and the medium-long term water demand actual value to obtain a first prediction error and the inputting the first prediction error into an artificial neutral network model to repeatedly conduct a prediction so as to obtain a second prediction error, further comprising:
training the artificial neural network model according to the historical water demand data set.

5. A system for predicting a medium-long term water demand of a water supply network, comprising:
a gray model building module, used for building a gray model;
a data set acquiring module, used for acquiring an urban historical water demand data set;
a data set processing module, used for processing the historical water demand data set to obtain a processed water demand data set;
a medium-long term water demand prediction value determining module, used for inputting the processed water demand data set into the gray model to obtain a medium-long term water demand prediction value;
a water demand actual value acquiring module, used for acquiring a medium-long term water demand actual value;
a first prediction error determining module, used for obtaining a first prediction error according to the medium-long term water demand prediction value and the medium-long term water demand actual value;
a second prediction error determining module, used for inputting the first prediction error into an artificial neutral network model to repeatedly conduct a prediction so as to obtain a second prediction error; and
a water supply network medium-long term water demand predicting module, used for predicting a medium-long term water demand of the water supply network according to the medium-long term water demand prediction value and the second prediction error.

6. The system for predicting a medium-long term water demand of a water supply network according to claim 5, wherein the data set processing module specifically comprises:
a data set processing unit used for processing the historical water demand data set by utilizing a moving average method to obtain a processed water demand data set.

7. The system for predicting a medium-long term water demand of a water supply network according to claim 5, wherein the first prediction error determining module specifically comprises:
a first prediction error determining unit used for calculating a difference between the medium-long term water demand prediction value and the medium-long term water demand actual value to obtain a first prediction error.

8. The system for predicting a medium-long term water demand of a water supply network according to claim 5, further comprising:
a training module used for training the artificial neural network model according to the historical water demand data set.
